(19) United States
(12) Patent Application Publication
(10) Pub. No.: US 2006/0224564 A1
(43) Pub. Date: Oct. 5, 2006

(54) Materialized view tuning and usability enhancement

(75) Inventors: Tsae-Feng Yu, Nashua, NH (US); Jack Raitto, Hollis, NH (US); Thomas Winglin Tong, Briarcliff Manor, NY (US); Min Xiao, Nashua, NH (US)

Correspondence Address: PERMAN & GREEN, LLP, 425 POST ROAD, FAIRFIELD, CT, 06824, US

(73) Assignee: ORACLE INTERNATIONAL CORPORATION, REDWOOD SHORES, CA (US)

(21) Appl. No.: 11/124,480

(22) Filed: May 6, 2005

Related U.S. Application Data
(60) Provisional application No. 60/667,183, filed on Mar. 31, 2005.

(51) Int. Cl. G06F 17/30

(52) U.S. Cl. 707/2

(57) ABSTRACT

A method and system for enhancing a materialized view. In one embodiment the method includes analyzing a defined query of the materialized view, checking the requirements of the materialized view log, generating execution scripts that automatically create and enhance the materialized view logs and tuning the materialized view.

### CROSS REFERENCE TO RELATED APPLICATIONS

This application claims the benefit of U.S. Provisional Patent Application entitled MATERIALIZED VIEW TUNING AND USABILITY ENHANCEMENT, filed on Mar. 31, 2005, via Express Mail No. EV 327711064 US.

### BACKGROUND OF THE INVENTION

1. Field of the Invention

The present invention relates to materialized view creation, fixing and decomposition and, more particularly, to automating the materialized view creation, fixing and decomposition process.

2. Brief Description of Related Developments

A materialized view (“MV”) is generally a database object that includes the results of a query. Copies of local data can be located remotely, or are used to create summary tables based on aggregations of data in a table. Materialized views are used to pre-compute query results in order to speed performance. Designing a materialized view is a complex problem requiring considerable skill and expertise in order to achieve performance goals while minimizing materialized view maintenance costs. These goals can only be achieved by designing a materialized view that can be refreshed incrementally and that can be used to answer the broadest set of request queries possible.

The materialized views used for query rewrite to speed up query performance are generally of two types, Materialized Aggregate View (“MAV”) and Materialized Join View (“MJV”).

The materialized view technology has been widely used in the data warehouse systems as a popular database object to improve query performance. Two key underlying techniques are materialized view incremental refresh and query rewrite. However, due to the potential complexity of the materialized view defining query and dependency on the materialized view log, not all materialized views are incrementally refreshable or generally query rewritable. Many restrictions need to be applied and addressed which make the materialized view not easy to use. For example, when the materialized view log of the base table is missing or insufficient, or the materialized view has a UNION set operator in its defining query, the materialized view is not incrementally refreshable.

For example, one problem that has been encountered, is trying to create a materialized view that is incrementally refreshable and capable of being used for general (i.e., non-text match) query rewrite. In ORACLE 9i, the EXPLAIN_MVIEW API is introduced which explains why the materialized view was not incrementally refreshable or generally rewritable. However, this only alleviates, but does not fix, the problem. Users still need to manually fix their materialized view statements to meet the refresh/rewrite requirements and to work around the restrictions. It would be advantageous to be able to bridge the usage gap that alleviates the need to manually correct the materialized view statements.

Tackling such usability problem is a very challenging job due to complexity. Fulfilling usability requirement is a non-trivial task. Ideally, the ultimate usability support for creating a materialized view is to completely automate the correction/creation and decomposition process. However, since if a materialized view defining query is ambiguously or badly written, it could be interpreted in many ways. Full creation automation may not generate the materialized view that the users mean to. It would thus be advantageous to be able to automate the creation, fixing and decomposition process through the script generation which allows the users to verify and review the creation plan before the implementation.

### SUMMARY OF THE INVENTION

The present invention is directed to a method of tuning a materialized view. In one embodiment the method includes analyzing a defined query of the materialized view, checking the requirements of the materialized view log, generating execution scripts that automatically create and enhance the materialized view logs and tuning the materialized view.

### BRIEF DESCRIPTION OF THE DRAWINGS

The foregoing aspects and other features of the present invention are explained in the following description, taken in connection with the accompanying drawings, wherein:

FIG. 1 is one embodiment of a system incorporating features of the present invention.

FIG. 2 is one embodiment of a method incorporating features of the present invention.

FIG. 3 is one embodiment of a design view for a system incorporating features of the present invention.

FIG. 4 is an embodiment of a system incorporating features of the present invention.

FIG. 5 is a block diagram of one embodiment of a typical apparatus that can be used to practice the present invention.

### DETAILED DESCRIPTION OF THE PREFERRED EMBODIMENT(S)

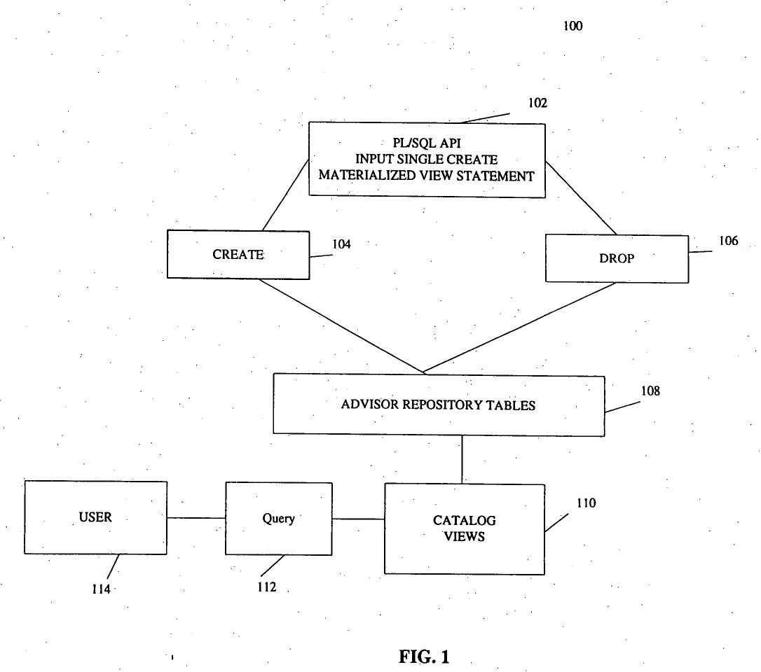

Referring to FIG. 1, one embodiment of a system and process incorporating features of the present invention is illustrated. Although the present invention will be described with reference to the embodiments shown in the drawings, it should be understood that the present invention can be embodied in many alternate forms of embodiments. In addition, any suitable size, shape or type of elements or materials could be used.

As generally illustrated in FIG. 1, an input single CREATE MATERIALIZED VIEW statement 102 is processed and two sets 104, 106 of executing plans or output scripts are outputted. In the example shown in FIG. 1, the application programming interface (“API”) takes two parameters, CREATE MATERIALIZED VIEW as the statement to be tuned, and an output parameter of task_id, which will be assigned with a system generated task id for looking up the recommendations through the catalog views, *_TUNE_MVIEW. The general API of FIG. 1 can generally take the form:

DBMS_ADVISOR.TUNE_MVIEW(:task_id, ‘create mv statement’);

In alternate embodiments, the present invention is not bound by the form of the API and any suitable form of API can be used to carry out the present invention.

In this embodiment, the API illustrated with respect to FIG. 1 generates the two sets of output scripts 104, 106. In alternate embodiments, any number of output scripts can be generated. For example, more than two sets of output sets could be generated. One output 104 is for the CREATE process while the other output 106 is for the DROP process. The CREATE process 104 allows users to create any database objects that achieve CREATE MATERIALIZED VIEW goals. Those objects broadly include tables, such as for example materialized views (“MV”), materialized view logs, rewrite equivalences and others. The DROP process 106 allows a user to drop just about anything that is created. Each output can be recorded in for example, advisor repository tables and are accessible through catalog views. While the disclosed embodiments are generally described herein as being embodied in an API, the present invention could also be a command line or a graphical user interface (“GUI”) or any applicable form.

Referring to FIG. 1, the output for the Create Process 104 will include create statements for both the materialized view log and the materialized view creations. The “CREATE MATERIALIZED VIEW LOG and ALTER MATERIALIZED VIEW LOG FORCE” statements automatically fix any MV log problems, such as for example, the non-existence of the MV log or missing columns in the MV log required for materialized view fast refresh. The “ALTER MATERIALIZED VIEW LOG” statement syntax, or a suitable equivalent, is extended to allow appending new columns, even if the MV log or log columns exist.

Through a single API call, a given CREATE MATERIALIZED VIEW statement 102 of FIG. 1 is analyzed and optimized to output both CREATE 104 (IMPLEMENTATION) and DROP 106 (UNDO) scripts, each of which can include one, or a sequential list, of execution statements. By executing the IMPLEMENTATION or CREATE script, a novice user is able to create the materialized view without needing complete knowledge about the materialized view requirements and restrictions. Or, if the user decides to undo the implementation effect, the UNDO or DROP script is ready to be launched.

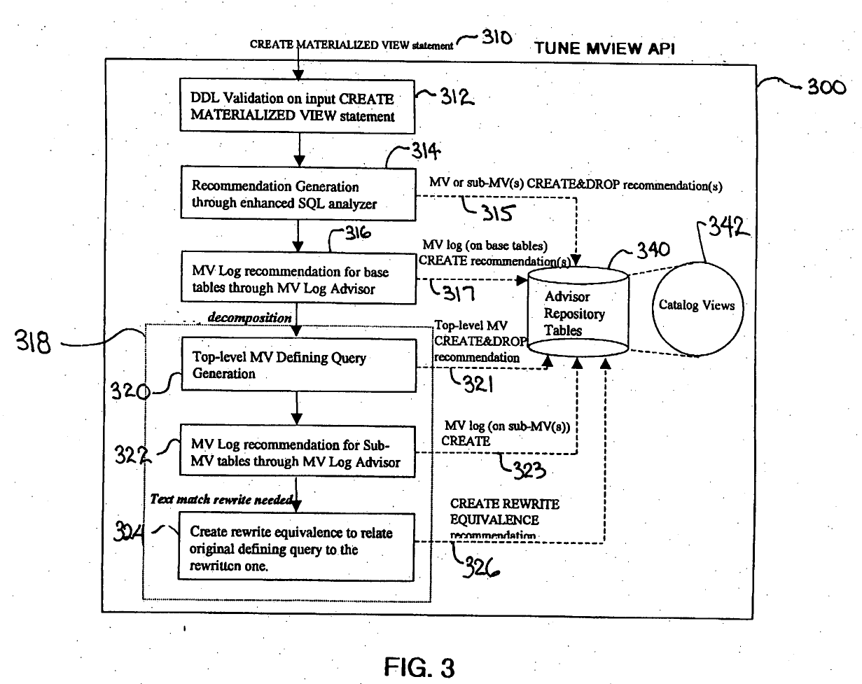

With reference to FIGS. 1 and 3, in one embodiment, the TUNE_MVIEW API component 300 of the present invention can be part of a DBMS_ADVSORY package API, for example. While the present invention is generally described herein in terms of the DBMS_ADVSORY package API, it will be understood that the scope of the disclosed embodiments are not so limited and the disclosed embodiments are not limited by any particular form of the API.

The API component 300 takes two parameters to generate its output. The input parameter of CREATE MATERIALIZED VIEW statement 310 and the output parameter of task_id. The materialized view creation statement is the target to be tuned and the output parameter of task_id is returned by the API to give an access handle to the catalog views 110, 342. It is noted that the use of task id herein is merely one example of an implementation of accessing the TUNE_MVIEW recommendation. In alternate emodiments, it can be generalized in any possible and suitable way.

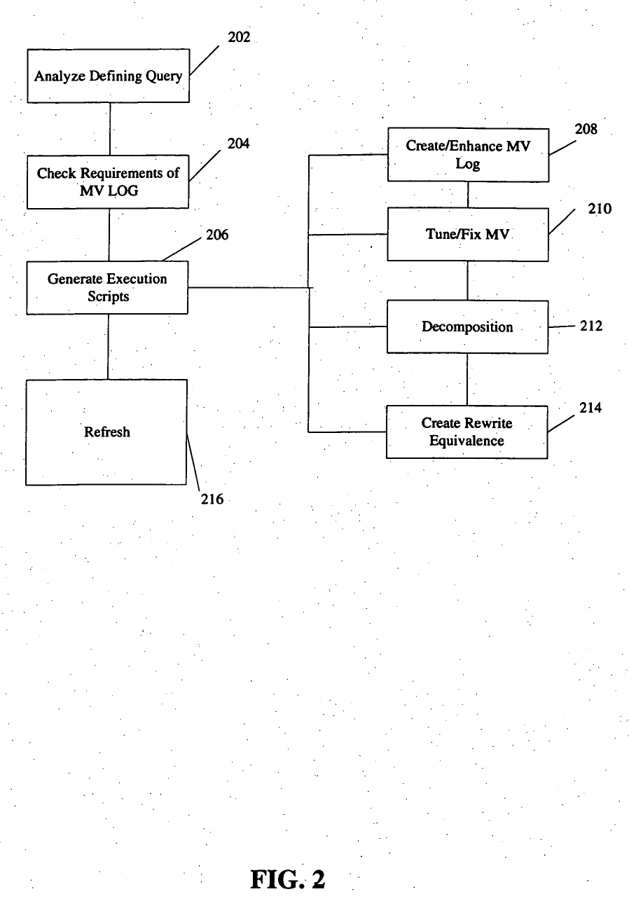

FIG. 2 is a flowchart of one embodiment of a process incorporating features of the present invention. As illustrated in FIG. 2, the disclosed embodiments support ease of use in the materialized view creation by automatically analyzing 202 the defining query of the materialized view, checking 204 the requirements of materialized view log and generating 206 the execution scripts. The execution scripts can include for example, scripts 208 that automatically create/enhance the materialized view logs, scripts 210 that tune/fix the materialized view, scripts 212 that decompose the defining query to create 216 a number of sub-materialized views and scripts 214 that create rewrite equivalence to link the modified materialized view defining query to the original one.

As referred to in FIG. 2, the materialized view is decomposed 214 into two or more materialized views or the materialized view is restated 216 in a way that is more advantageous for fast refresh and query rewrite. In one embodiment, the defining query of the materialized view can generallly include any of the following:
set operators
analytical (windowing) functions (optional and its design is not covered in the document)
COUNT DISTINCT
SELECT DISTINCT
non-flattenable inline view and subquery in the WHERE/HAVING clauses
model clause (optional and its design is not covered in the document)

In one embodiment, the TUNE_MVIEW API 300 generates two sets of outputs, accessible through catalog views 342. One set of the output is for creating materialized view(s) and required materialized view logs to achieve fast refreshability and general rewritablity as much as possible. The other set of the output is for dropping the materialized view objects to undo the creation of the materialized views in case the user decides they are not required.

The creation output or create statement output 104 generated from the API 300 is to fix the materialized view's defining query to enable fast refresh and query rewrite (i.e., add required aggregate columns and/or decompose into a number of sub-materialized views) and fix any materialized view log problems such as missing materialized view logs or missing required columns in the materialized view log. It is a feature of the present invention to automatically enhance and tune a user-specified materialized view definition. In one embodiment, this can generally include automatically creating, fixing or decomposing a complex, user-specified materialized view definition into a set of one or more simpler, more capable, materialized view definitions. Additionally, required columns can be automatically added to support certain materialized view capabilities. These can include for example, incremental refresh and the ability to use the materialized view to answer a broader set of requests. Furthermore, complex SQL forms can be automatically rendered into equivalent, simpler SQL forms. In one embodiment, these can include for example, transforming SELECT DISTINCT X into SELECT X . . . GROUP BY X. The materialized view environment can be automatically conditioned to enhance materialized view capabilities, including, for example, the addition of new, or the enhancement of existing, materialized view logs, the addition of new, or the enhancement of, existing constraint definitions, and the addition of new, or the enhancement of, existing dimension definitions.

Materialized view decomposition is a mechanism to decompose a non-fast refreshable materialized view into a number of sub-materialized views, each of which becomes rewritable and fast refreshable. Fast refreshability is thus achieved. The decomposition mechanism is also used when, for example, ENABLE QUERY REWRITE is specified in the MV CREATE statement so that general query rewrite is possible for a materialized view statement with set operators in its defining query. The term “fast refreshable” or “fast refresh” is generally defined as “substantially faster” than complete refresh. Fast refresh may not be instantaneous. General rewrite refers to non-text match query rewrite techniques.

The embodiments of the present invention apply expert transformations of a user specified materialized view definition that results in an enhanced materialized view definition that is incrementally refreshable and answers to a broader set of request queries.

In some instances, the materialized view defining query itself is not fast refreshable. If possible, the materialized view defining query will be decomposed into sub-materialized views so that some or all of the sub-materialized views are fast refreshable. When decomposition occurs, the output will contain for example, a list of CREATE MATERIALIZED VIEW statements for creating sub-materialized views and the original materialized view, which is modified to reference sub-materialized views. Since creating additional sub-materialized views implies storage requirement, each CREATE MATERIALIZED VIEW statement will include an estimate of the storage requirements.

For example, the materialized view decomposition mechanism can handle cases where the materialized defining query has set operators (i.e., UNION, UNION ALL, MINUS and INTERSECT) or the materialized view defining query has inline view(s) or subqueries in WHERE/HAVING CLAUSES. Decomposition can be applied to other types of constructs as well, (but is not limited to), such as for example, model and windowing functions.

If the materialized view defining query cannot benefit from the decomposition/modification (create/fix) to meet the specified requirements of fast refresh and/or enable query rewrite, an error will be thrown to indicate that it is not possible.

For example, we have a materialized view for each of the UNION members. One or both members are refreshed and then the whole (top operation) is recomputed. The contributing element is incrementally maintained.

In some situations, the sub-materialized view calculation may be more expensive and the top operation calculation may be less expensive. For example, with a “LOSS” the information is not there. Thus it is not fast refreshable.

The sub-materialized views can be used for other operations as well. Thus, the temporary result is saved, which increases the service domain such as query rewrite.

The output for the DROP process contains drop statements to reverse the materialized view creations. The “DROP MATERIALIZED VIEW” statements drop the materialized views created in the output for the CREATE process. The drop process can support restartability for the Create process.

Embodiments of the present invention can also utilize rewrite equivalences. Rewrite equivalences declare two SQL queries to be logically equivalent, yet also declare one of the equivalent queries to be more favorable for performance, including for example, automatic point-in-time validation of rewrite equivalences, and continuous validation of rewrite equivalences. The application of rewrite equivalences to the decomposition problem can include, for example, the use of checksum to ensure integrity of the TUNE_MVIEW API, determined rewrite equivalences and the use of rewrite equivalences to logically and efficiently bind together decomposed elements into a logical result.

For example, in one embodiment, a conditionally generated “BUILD_SAFE_REWRITE_EQUIVALENCE” API command may also be included to ensure that text match query rewrite uses the modified top-level materialized view defining query.

The present invention provides for the automatic decomposition/transformation of the materialized view defining query to achieve better query rewrite and fast refresh results. For example, in one embodiment,

SELECT DISTINCT a,b,c FROM x;

can be transformed as follows to support fast refresh: SELECT a,b,c, COUNT(*) AS cnt FROM x GROUP BY a,b,c;.

This transformation replaces a SELECT DISTINCT query with an equivalent GROUP BY query. Note that the second query returns the same rows and a superset of the columns of the first query. The important difference is that the GROUP BY allows the addition of the COUNT(*) column to support fast refresh. Many such transformation opportunities exist, for example: Set operators (UNION, UNION ALL, MINUS, INTERSECT), analytical functions and sub-queries.

The present invention also provides for the automation of materialized view creation. The implementation of materialized views can be hampered by one or more problems including missing or inadequate materialized view logs, missing maintenance columns and unsupported constructs.

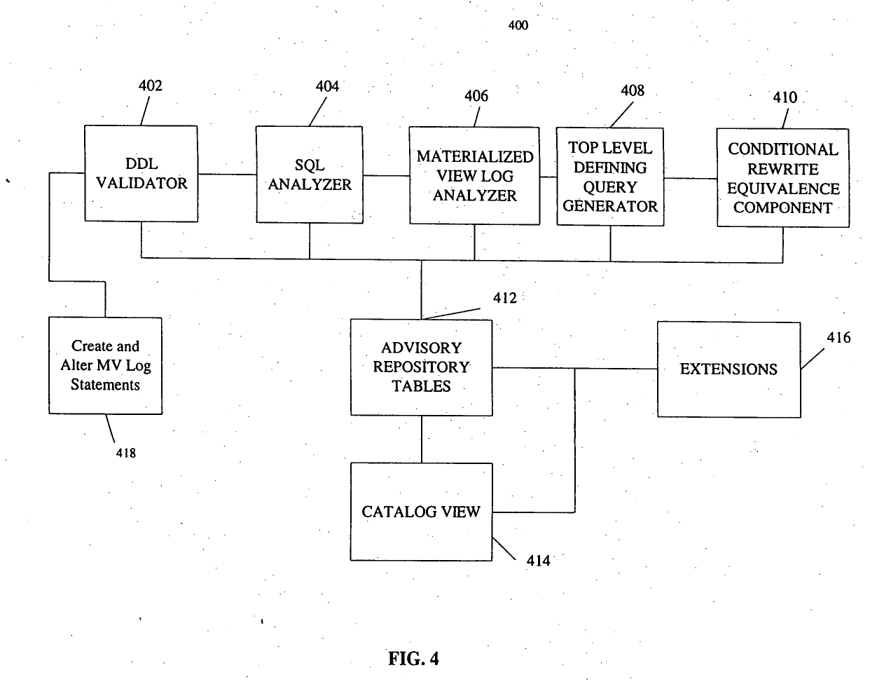

Referring to FIG. 4, one embodiment of a system 400 incorporating features of the present invention is illustrated. The system 400 generally comprises a DDL Validation component, 402, a SQL Analyzer component 404, a Materialized View Log Analyzer 406, a Top-Level Defining Query Generator 408, a Conditionally create rewrite equivalence component 410, an Advisory Repository Table 412, a Catalog view component 414, extensions 416 to the Advisory Repository table 412 and Catalog views 414, and a CREATE and an ALTER MATERIALIZED VIEW LOG statements component 418. In alternate embodiments, the system 400 can include such other suitable components to provide an enhanced materialized view definition that is incrementally refreshable. It is a feature of the present invention to automatically enhance a user specified materialized view definition.

Referring to FIGS. 3 and 4, in one embodiment, the TUNE_MVIEW API 300 takes a CREATE MATERIALIZED VIEW statement as its input 310. The statement is first examined and validated 312 through the DDL Validation component 402 shown in FIG. 4. This component 402 checks the CREATE statement 310 to see if it can be tuned. For example, the input CREATE MATERIALIZED VIEW statement to be tuned is first processed through an internal DDL validation API, DBMS_ADVISOR_INTERNAL.VALIDATE_TUNE_MV( ) to do a preliminary check on the CREATE statement to see if it can benefit from the tuning process. If the materialized view to be tuned has a complex defining query (e.g., having a non-repeatable-read expression such as SYSDATE) that cannot be optimized or improved in this API, this validation component will detect it and return an error message showing that the CREATE statement cannot be tuned. Otherwise, the CREATE statement is identified as tunable and will be forwarded to the SQL Analyzer component 404.

The design of, for example, the DBMS_ADVISOR_INTERNAL.VALIDATE_TUNE_MV( ) API 400 makes use of the implementation of EXPLAIN_MVIEW. Currently, the EXPLAIN_MVIEW will stop the validation when the materialized view or the potential materialized view is identified to be complex. The EXPLAIN_MVIEW code and functionality is extended so that it can still continue the validation and try to find all the reasons that make the materialized view complex. At the same time, the materialized view is marked “non-tunable” if the reason that causes the complex materialized view is not tuneable (e.g., SYSDATE in the subquery). The VALIDATE_TUNE_MV( ) API will call the EXPLAIN_MVIEW's VARRAY interface that returns the results in a VARRAY. The results will be used to match with the REFRESH and QUERY REWRITE property clauses to decide if the defining query should be submitted to the SQL Analyzer SYSTEM 404 for further processing.

The SQL Analyzer 404 analyzes 314 the defining query of the CREATE MATERIALIZED VIEW statement, starts to do query modification, creation, fixing or decomposition and generates recommendations 315 of partial execution plans. The recommendations 315 comprise two parts, CREATE (IMPLEMENTATION) and DROP (UNDO). The IMPLEMENTATION part of the recommendations 315 has one or more CREATE MATERIALIZED VIEW statements. The statement(s) represent either a modified CREATE materialized view recommendation (simple defining query modification) or CREATE sub-materialized view(s) recommendation (as a result of decomposition). If decomposition occurs, all the recommended sub-materialized views are fixed to meet the requested requirements (i.e., incremental refresh and/or query rewrite) and will cover new sub-materialized views in the CREATE MATERIALIZED VIEW statements. While generating CREATE MATERIALIZED VIEW statements, some comments regarding storage requirements for the recommended materialized views are also generated through statistics estimates from the base table. On the other hand, the DROP part of the recommendations includes one or more DROP MATERIALIZED VIEW statements to reverse IMPLEMENTATION operations in case the execution plan should be restarted. Both of the CREATE and DROP statements are recorded in the Advisor Repository Tables 340.

To support the incremental refresh requirement, the recommended CREATE MATERIALIZED VIEW statements from the SQL analyzer 404 may not be executable without the presence of required materialized view logs. For example, if the generated CREATE MATERIALIZED VIEW statements have the REFRESH FAST option specified, the materialized view logs of all base tables must exist so that the generated statements can be executed successfully. To support this, the Materialized View Log Analyzer or Advisor component 406 takes and analyzes 316 the generated CREATE MATERIALIZED VIEW statements by checking the base tables in the materialized view recommendations 315 (for fast refresh). If the materialized view logs are not sufficient, the MV Log Analyzer 406 generates the recommendations 317 of CREATE and ALTER MATERIALIZED VIEW LOG FORCE statements for each base table. These CREATE and ALTER MATERIALIZED VIEW LOG FORCE statements are to create

materialized view logs on base tables if the materialized view logs do not exist and to amend the existing Materialized View logs with required filter columns and/or other elements, such as for example, ROWID. The CREATE and ALTER MATERIALIZED VIEW LOG FORCE statements are recorded in the Advisor Repository Tables 340 for script generation and can also be marked with operation sequence numbers.

If the defining query of the input CREATE MATERIALIZED VIEW statement cannot be tuned through simple query modification, decomposition 318 is applied through the SQL Analyzer 404 to divide the defining query into a number of sub-queries, some or all of which satisfy the specified requirements (e.g., REFRESH FAST and/or ENABLE QUERY REWRITE). Each sub-query is then generated and used as the defining query of a sub-materialized view. The CREATE statement generation for the sub-materialized views is through the SQL Analyzer 404, while the original defining query of the input CREATE MATERIALIZED VIEW statement is modified to reference these sub-materialized views as, for example, a nested materialized view. It is noted that a nested materialized view is a materialized view that makes reference to other materialized views.

The generation 320 of the top-level CREATE MATERIALIZED VIEW statement is achieved through the use of the query rewrite engines 408. Before invoking the query rewrite engine 408, the sub-materialized views will be first created with the BUILD DEFERRED option so they are ready for query rewrite to use. The rewrite engine 408 conditionally uses BUILD DEFERRED materialized views for query rewrite. A flag will be passed to tell the rewrite engine 408 of the special purpose. Then, the original defining query will be submitted for the rewrite engines 408 to modify. The original defining query will be rewritten in terms of sub materialized views to become a modified defining query. The modified defining query is then used in the CREATE MATERIALIZED VIEW statement to replace the original defining query. The new top-level CREATE MATERIALIZED VIEW statement is also recorded in the Advisor Repository Tables 340 along with the comment of storage requirements estimate. In addition, the corresponding DROP statement for the top-level materialized view is generated and recorded at the same time. For example, the defining query of the input CREATE MATERIALIZED VIEW statement is passed 320 to the top-level defining query generator API 408. The API 408 uses the enhanced query rewrite algorithm to rewrite the defining query (referencing base tables) as a rewritten query (referencing sub-materialized views). The rewritten query is the new defining query of the top-level materialized views. The storage estimates for the recommended top-level materialized view will be generated based on the statistics information from the sub-materialized views (through estimate statistics derived from the base tables).

In some cases, after decomposition, the modified top-level materialized view is also incrementally (fast) refreshable. To enable the REFRESH FAST option, for example, for the top-level materialized view, the materialized view logs on the sub-materialized views are required. Therefore, the second call to the Materialized View Log Advisor 406 is invoked to generate 322 the recommendation 323 of CREATE and ALTER MATERIALIZED VIEW LOG statements on the sub-materialized views. The CREATE and ALTER MATERIALIZED VIEW LOG statements for the sub-materialized views are recorded in the Advisor Repository Tables 340, and can be marked with operation sequence numbers.

After generating recommendations 323 for the top-level defining query and its required materialized view logs, the final step is to generate 324 the recommendation 325 of a rewrite equivalence rule to relate the original defining query to the modified defining query using the rewrite equivalence component 410. This is only needed when the original defining query can only adopt text match rewrite. A typical example is when the defining query has sub-queries where general rewrite is not possible. It is noted that this step may not be needed in all cases.

For example, in one embodiment, the generated statements for the IMPLEMENTATION plan have the following dependency order:
1. CREATE and/or ALTER MATERIALIZED VIEW LOG on the base tables.
2. CREATE MATERIALIZED VIEW for sub-materialized view (in case of decomposition).
3. CREATE and/or ALTER MATERIALIZED VIEW LOG on the sub-Materialized View (in case of decomposition).
4. CREATE MATERIALIZED VIEW for top-level MATERIALIZED VIEW.
5. BUILD_SAFE_REWRITE_EQUVIVALENCE API call (in case of need for text match rewrite).

In a similar embodiment, the generated statements for the UNDO plan have the following dependency order:
1. DROP top-level materialized view.
2. DROP sub-materialized views (in case of decomposition).
3. DROP_REWRITE_EQUVIVALENCE API call (in case of need for text match rewrite).

To distinguish the script type (i.e., IMPLEMENTATION/UNDO) and to enforce the dependency order, each output statement recorded in the Repository Tables 340, 412 is labeled with a script type and an “operation sequence” number. The script type is to tell which script the statement belongs to. The operation sequence number ensures the execution order of the statements in the script.

After the execution of the TUNE_MVIEW call, the user can query catalog views 342, 414 to access the output recommendations and compose them in a preferred format (e.q. SQL* PLUS), order by script type and the sequence number. Alternatively, the IMPLEMENTATION and UNDO scripts can be saved in specified files by calling Access Advisor's script generation APIs.

The exemplary embodiment of the PL/SQL API including features of the present invention is referred to herein as TUNE_MVIEW, and can be created in the package DBMS_ADVISOR. In this example, its general form is TUNE_MVIEW (task_name, <mv_create_stmt>). It takes <mv_create_stmt> as input and generates two sets of output (i.e., for create and drop) stored in the Advisor repository tables. The user can access the information through catalog views with the task_name parameter. The task_name can be supplied by the user or if not supplied, can be generated and returned by the system. After querying the output result from the repository tables, the user has the freedom to review and/or modify the output texts.

The following three examples illustrate part of important functionality of the present invention in the exemplary embodiment of the TUNE_MVIEW API:

### EXAMPLE 1

### Directly Fix the Defining Query of the Materialized View

Input: Assume that both base tables, STORE and FACT, have materialized view logs already.

execute dbms_advisor.tune_mview (:my_task_name,
‘CREATE MATERIALIZED VIEW cust_sales_mv
BUILD IMMEDIATE
REFRESH FAST
ENABLE QUERY REWRITE
AS
SELECT s.store_name, sum(f.dollar_sales) AS sales,
   sum(f.dollar_cost) as cost
FROM store s, fact f
WHERE s.store_key=f.store_key
GROUP BY s.store_name’);
   Output: Two output scripts, IMPLEMENTATION and UNDO, are generated by TUNE_MVIEW.
   The IMPLEMENTATION script:

CREATE MATERIALIZED VIEW GROCERY2.CUST_SALES_MV

BUILD IMMEDIATE

REFRESH FAST

WITH ROWID

ENABLE QUERY REWRITE

AS

SELECT GROCERY2.STORE.STORE_NAME C1,
SUM(“GROCERY2”.“FACT”.“DOLLAR_COST”) M1,
COUNT (“GROCERY2”.“FACT”.“DOLLAR_COST”) M2,
SUM(“GROCERY2”.“FACT”.“DOLLAR_SALES”) M3,
COUNT(“GROCERY2”.“FACT”.“DOLLAR_SALES”) M4,
COUNT(*) M5

FROM GROCERY2.STORE, GROCERY2.FACT

WHERE GROCERY2.FACT.STORE_KEY=GROCERY2.STORE.STORE_KEY

GROUP BY GROCERY2.STORE.STORE_NAME;

The UNDO script:

DROP MATERIALIZED VIEW GROCERY2.CUST_SALES_MV;

In this example, the original defining query is not sufficient for fast refresh due to missing columns. The TUNE_MVIEW analyzes the defining query and adds three additional COUNT columns (M2, M4 and M5) to make the materialized view support general query rewrite (as seen in the IMPLEMENTATION script output). The UNDO script contains one DROP MATERIALIZED VIEW statement to undo the effect.

### EXAMPLE 2

Decomposition of materialized view defining query. This example shows the materialized views defining query with set operators is decomposed as a number of sub-materialized views.

Input: The base tables SALES, CUSTOMER and COUNTRY do not have materialized view logs. The user is to execute the following statement with a given CREATE MATERIALIZED VIEW statement:

execute dbms_advisor.tune_mview (:my_task_name,
‘CREATE MATERIALIZED VIEW cust_mv
REFRESH FAST ON DEMAND
ENABLE QUERY REWRITE
AS
SELECT s.prod_id, s.cust_id, count(*) cnt,
   sum(s.amount_sold) sum_amount
FROM sales s, customer cs, country cn WHERE s.cust_id=cs.cust_id AND
   cs.country_id=cn.country_id AND
   cn.country_name in (‘USA’,‘Canada’)
GROUP BY s.prod_id, s.cust_id
UNION
SELECT s.prod_id, s.cust_id, count(*) cnt,
   sum(s.amount_sold) sum_amount
FROM sales s, customer cs
WHERE s.cust_id=cs.cust_id AND
   s.cust_id in (1005, 1010, 1012)
GROUP BY s.prod_id, s.cust_id’);

The MATERIALIZED VIEW defining query contains a UNION set-operator so that the materialized view itself is not fast-refreshable. It requires decomposition.

Output: Two output scripts, IMPLEMENTATION and UNDO, are generated by TUNE_MVIEW. The IMPLEMENTATION script will be created along with two sub-materialized views as follows.

Create and Fix Materialized View Logs
CREATE MATERIALIZED VIEW LOG ON “SH”.“CUSTOMERS” WITH ROWID, SEQUENCE(“CUST_ID”) INCLUDING NEW VALUES;
ALTER MATERIALIZED VIEW LOG FORCE ON “SH”.“CUSTOMERS” ADD ROWID, SEQUENCE(“CUST_ID”) INCLUDING NEW VALUES;
CREATE MATERIALIZED VIEW LOG ON “SH”.“SALES” WITH ROWID, SEQUENCE(“PROD_ID”,“CUST_ID”,“AMOUNT_SOLD”) INCLUDING NEW VALUES;
ALTER MATERIALIZED VIEW LOG FORCE ON “SH”.“SALES” ADD ROWID, SEQUENCE(“PROD_ID”,“CUST_ID”,“AMOUNT_SOLD”) INCLUDING NEW VALUES;
CREATE MATERIALIZED VIEW LOG ON “SH”.“COUNTRIES” WITH ROWID, SEQUENCE(“COUNTRY_ID”,“COUNTRY_NAME”) INCLUDING NEW VALUES;
ALTER MATERIALIZED VIEW LOG FORCE ON “SH”.“COUNTRIES” ADD ROWID, SEQUENCE(“COUNTRY_ID”,“COUNTRY_NAME”) INCLUDING NEW VALUES;
ALTER MATERIALIZED VIEW LOG FORCE ON “SH”.“CUSTOMERS” ADD ROWID, SEQUENCE(“CUST_ID”,“COUNTRY_ID”) INCLUDING NEW VALUES;
ALTER MATERIALIZED VIEW LOG FORCE ON “SH”.“SALES” ADD ROWID, SEQUENCE(“PROD_ID”,“CUST_ID”,“AMOUNT_SOLD”) INCLUDING NEW VALUES;

Create Sub Materialized Views and Top-Level Materialized View
CREATE MATERIALIZED VIEW SH.CUST_MV$SUB1
   REFRESH FAST WITH ROWID ON COMMIT
   ENABLE QUERY REWRITE
   AS
   SELECT SH.SALES.PROD_ID C1, SH.CUSTOMERS.CUST_ID C2,
      SUM(“SH”.“SALES”.“AMOUNT_SOLD”) M1,
      COUNT(“SH”.“SALES”.“AMOUNT_SOLD”) M2, COUNT(*) M3
   FROM SH.SALES, SH.CUSTOMERS
   WHERE SH.CUSTOMERS.CUST_ID=SH.SALES.CUST_ID AND
      (SH.SALES.CUST_ID IN (1012, 1010, 1005))
   GROUP BY SH.SALES.PROD_ID, SH.CUSTOMERS.CUST_ID;
   CREATE MATERIALIZED VIEW SH.CUST_MV$SUB2
   REFRESH FAST WITH ROWID ON COMMIT
   ENABLE QUERY REWRITE
   AS
   SELECT SH.SALES.PROD_ID C1, SH.CUSTOMERS.CUST_ID C2,
      SH.COUNTRIES.COUNTRY_NAME C3,
      SUM(“SH”.“SALES”.“AMOUNT_SOLD”) M1,
      COUNT(“SH”.“SALES”.“AMOUNT_SOLD”) M2, COUNT(*) M3
   FROM SH.SALES, SH.CUSTOMERS, SH.COUNTRIES
   WHERE SH.CUSTOMERS.CUST_ID=SH.SALES.CUST_ID AND
      SH.COUNTRIES.COUNTRY_ID=SH.CUSTOMERS.COUNTRY_ID AND
      (SH.COUNTRIES.COUNTRY_NAME IN (‘USA’, ‘Canada’))
   GROUP BY SH.SALES.PROD_ID, SH.CUSTOMERS.CUST_ID,
      SH.COUNTRIES.COUNTRY_NAME;
   CREATE MATERIALIZED VIEW SH.CUST_MV
   REFRESH FORCE WITH ROWID
   ENABLE QUERY REWRITE
   AS
   (SELECT “CUST_MV$SUB2”.“C1” “PROD_ID”,“CUST_MV$SUB2”.“C2”
      “CUST_ID”,SUM (“CUST_MV$SUB2”. “M3”)
      “CNT”,SUM(“CUST_MV$SUB2”.“M1”) “SUM_AMOUNT”
   FROM “SH”.“CUST_MV$SUB2” “CUST_MV$SUB2”
   GROUP BY “CUST_MV$SUB2”.“C1”,“CUST_MV$SUB2”.“C2”)
   UNION
   (SELECT “CUST_MV$SUB1”.“C1” “PROD_ID”,
      “CUST_MV$SUB1”.“C2” “CUST_ID”,
      SUM(“CUST_MV$SUB1”.“M3”) “CNT”,
      SUM (“CUST_MV$SUB1”.“M1”) “SUM_AMOUNT”
   FROM “SH”.“CUST_MV$SUB1” “CUST_MV$SUB1”
   GROUP BY “CUST_MV$SUB1”.“C1”,“CUST_MV$SUB1”.“C2”);

Create a Rewrite Equivalence to Link the Original Query to

The Created Materialized Views
EXECUTE
DBMS_ADVANCED_REWRITE.BUILD_SAFE_REWRITE_EQUIVALENCE (‘
SH.CUST_MV$RWEQ’,
‘SELECT s.prod_id, s.cust_id, COUNT(*) cnt,
   SUM(s.amount_sold) sum_amount
FROM sales s, customers cs, countries cn
WHERE s.cust_id=cs.cust_id AND cs.country_id=cn.country_id
   AND cn.country_name IN (“USA”,“Canada”)
GROUP BY s.prod_id, s.cust_id
UNION
SELECT s.prod_id, s.cust_id, COUNT(*) cnt,
   SUM(s.amount_sold) sum_amount
FROM sales s, customers cs
WHERE s.cust_id=cs.cust_id AND s.cust_id IN (1005, 1010, 1012)
GROUP BY s.prod_id, s.cust_id’,
‘(SELECT “CUST_MV$SUB2”.“C3”
   “PROD_ID”,“CUST_MV$SUB2”.“C2” “CUST_ID”,
      SUM(“CUST_MV$SUB2”.“M3”) “CNT”,
      SUM(“CUST_MV$SUB2”.“M1”) “SUM_AMOUNT”
   FROM “SH”.“CUST_MV$SUB2” “CUST_MV$SUB2”
   GROUP BY “CUST_MV$SUB2”.“C3”,“CUST_MV$SUB2”.“C2”)
   UNION
(SELECT “CUST_MV$SUB1”.“C2”
   “PROD_ID”,“CUST_MV$SUB1”.“C1” “CUST_ID”,
      “CUST_MV$SUB1”.“M3” “CNT”,“CUST_MV$SUB1”. “M1”
   “SUM_AMOUNT”
   FROM “SH”.“CUST_MV$SUB1” “CUST_MV$SUB1”)’,−1553577441);

The UNDO output is as follows:

Drop Sub and Top-Level Materialized Views and Rewrite Equivalence
DROP MATERIALIZED VIEW SH.CUST_MV$SUB1;
DROP MATERIALIZED VIEW SH.CUST_MV$SUB2;
DROP MATERIALIZED VIEW SH.CUST_MV;
DBMS_ADVANCED_REWRITE.DROP_REWRITE_EQUIVALENCE(‘SH.CUST_MV$R WEQ’);

In this example, the original defining query of cust_mv has been decomposed into two sub-materialized views, shown here as cust_mv$SUB1 and cust_mv$SUB2. One additional column cnt_amount has been added in cust_mv$SUB1 to make sure that the materialized view, cust_mv$SUB1, is fast refreshable. The original defining query of cust_mv has been modified to query the two sub-materialized views instead, where both sub-materialized views are fast refreshable. One rewrite equivalence relation is built to link the original defining query to the sub-materialized views for supporting query rewrite.

Any required materialized view logs can be added and fixed to enable fast refresh of the sub-materialized views. It is noted that, to support repeated executions of the IMPLEMENTATION script, each CREATE MATERIALIZED VIEW LOG is followed by an ALTER MATERIALIZED VIEW LOG FORCE statement to amend the materialized view log whenever needed. The ALTER MATERIALIZED VIEW LOG FORCE statement is re-executable which only appends the materialized view log.

### EXAMPLE 3

Optimization of materialized view defining query. This example shows that the materialized view defining query with set operators is transformed as an optimized defining query. In some cases, Sub-Select queries in the materialized view defining query are of similar shape and their selection predicates can be combined.

Input: The base tables SALES and CUSTOMER do not have materialized view logs. In this example, the user is to execute the following statement with a given CREATE MATERIALIZED VIEW statement:
execute dbms_advisor.tune_mview (:my_task_name,
   ‘CREATE MATERIALIZED VIEW cust_mv
   REFRESH FAST ON DEMAND
   ENABLE QUERY REWRITE
   AS
   SELECT s.prod_id, s.cust_id, COUNT(*) cnt,
SUM(s.amount_sold) sum_amount
   FROM sales s, customers cs
   WHERE s.cust_id=cs.cust_id AND s.cust_id IN (2005, 1020)
   GROUP BY s.prod_id, s.cust_id
   UNION
   SELECT s.prod_id, s.cust_id, COUNT(*) cnt,
SUM(s.amount_sold) sum_amount
   FROM sales s, customers cs
   WHERE s.cust_id=cs.cust_id AND s.cust_id IN (1005, 1010, 1012)
   GROUP BY s.prod_id, s.cust_id’);

The materialized view defining query contains a UNION set-operator so that the materialized view itself is not fast-refreshable. However, two sub-select queries in the materialized view defining query can be combined as one single query.

Output: The IMPLEMENTATION script will be created with an optimized sub-materialized view and a top-level materialized view for support query rewrite as follows.
CREATE MATERIALIZED VIEW LOG ON “SH”.“SALES” WITH ROWID, SEQUENCE (“PROD_ID”,“CUST_ID”,“AMOUNT_SOLD”) INCLUDING NEW VALUES;
ALTER MATERIALIZED VIEW LOG FORCE ON “SH”.“SALES” ADD ROWID, SEQUENCE (“PROD_ID”,“CUST_ID”,“AMOUNT_SOLD”) INCLUDING NEW VALUES;
CREATE MATERIALIZED VIEW LOG ON “SH”.“CUSTOMERS” WITH ROWID, SEQUENCE (“CUST_ID”) INCLUDING NEW VALUES;
ALTER MATERIALIZED VIEW LOG FORCE ON “SH”.“CUSTOMERS” ADD ROWID, SEQUENCE (“CUST_ID”) INCLUDING NEW VALUES;

CREATE MATERIALIZED VIEW SH.CUST_MV$SUB1
REFRESH FAST WITH ROWID
ENABLE QUERY REWRITE AS

SELECT SH.SALES.CUST_ID C1, SH.SALES.PROD_ID C2,
SUM(“SH”.“SALES”.“AMOUNT_SOLD”) M1,
COUNT(“SH”.“SALES”.“AMOUNT_SOLD”)M2, COUNT(*) M3

FROM SH.CUSTOMERS, SH.SALES

WHERE SH.SALES.CUST_ID=SH.CUSTOMERS.CUST_ID AND
(SH.SALES.CUST_ID IN (2005, 1020, 1012, 1010, 1005))

GROUP BY SH.SALES.CUST_ID, SH.SALES.PROD_ID;

CREATE MATERIALIZED VIEW SH.CUST_MV

REFRESH FORCE WITH ROWID

ENABLE QUERY REWRITE

AS
(SELECT “CUST_MV$SUB1”.“C2” “PROD_ID”,“CUST_MV$SUB1”.“C1”
   “CUST_ID”,
      “CUST_MV$SUB1”.“M3” “CNT”,“CUST_MV$SUB1”.“M1”
   “SUM_AMOUNT”
FROM “SH”.“CUST_MV$SUB1” “CUST_MV$SUB1”
WHERE “CUST_MV$SUB1”.“C1”=2005 OR
   “CUST_MV$SUB1”.“C1”=1020)
UNION
(SELECT “CUST_MV$SUB1”.“C2” “PROD_ID”,“CUST_MV$SUB1”.“C1”
   “CUST_ID”,
      “CUST_MV$SUB1”.“M3” “CNT”,“CUST_MV$SUB1”.“M1”
   “SUM_AMOUNT”
FROM “SH”.“CUST_MV$SUB1” “CUST_MV$SUB1”
WHERE “CUST_MV$SUB1”.“C1”=1012 OR “CUST_MV$SUB1”.“C1”=1010
   OR
      “CUST_MV$SUB1”.“C1”=1005);
EXECUTE
   DBMS_ADVANCED_REWRITE.BUILD_SAFE_REWRITE_EQUIVALENCE (‘SH.CUST_MV$RWEQ’,
      ‘SELECT s.prod_id, s.cust_id, COUNT(*) cnt,
         SUM(s.amount_sold) sum_amount
      FROM sales s, customers cs
      WHERE s.cust_id=cs.cust_id AND s.cust_id in (2005, 1020)
      GROUP BY s.prod_id, s.cust_id
      UNION
      SELECT s.prod_id, s.cust_id, COUNT(*) cnt,
         SUM(s.amount_sold) sum_amount
      FROM sales s, customers cs
      WHERE s.cust_id=cs.cust_id AND s.cust_id IN (1005, 1010, 1012)
      GROUP BY s.prod_id, s.cust_id’,
      ‘(SELECT “CUST_MV$SUB1”.“C2” “PROD_ID”,
         “CUST_MV$SUB1”.“C1” “CUST_ID”,
         “CUST_MV$SUB1”.“M3” “CNT”,
         “CUST_MV$SUB1”.“M1” “SUM_AMOUNT”
      FROM “SH”.“CUST_MV$SUB1” “CUST_MV$SUB1”
      WHERE “CUST_MV$SUB1”.“C1”=2005 OR
   “CUST_MV$SUB1”.“C1”=1020)
      UNION
      (SELECT “CUST_MV$SUB1”.“C2” “PROD_ID”,
         “CUST_MV$SUB1”.“C1” “CUST_ID”,
         “CUST_MV$SUB1”.“M3” “CNT”,
         “CUST_MV$SUB1”.“M1” “SUM_AMOUNT”
      FROM “SH”.“CUST_MV$SUB1” “CUST_MV$SUB1”
      WHERE “CUST_MV$SUB1”.“C1”=1012 OR
   “CUST_MV$SUB1”.“C1”=1010 OR
      “CUST_MV$SUB1”.“C1”=1005)’, 1811223110);

The UNDO output is as follows:
DROP MATERIALIZED VIEW SH.CUST_MV$SUB1;
DROP MATERIALIZED VIEW SH.CUST_MV;
DBMS_ADVANCED REWRITE.DROP REWRITE_EQUIVALENCE(‘SH.CUST_MV$R WEQ’);

The original defining query of cust_mv has been optimized by combining the selection predicates of the two sub-select queries in CUST_MV$SUB1. The required materialized view logs are added to enable fast refresh of the sub-materialized views.

The following example describes the syntax extension to the ALTER MATERIALIZED VIEW LOG statement to support the option to amend information captured by the materialized view log.

ALTER] MATERIALIZED VIEW LOG [FORCE] ON [schema
.] table

[ADD
{ OBJECT ID | PRIMARY KEY | ROWID | SEQUENCE | (

column [, column]... ) }

[, { OBJECT ID | PRIMARY KEY | ROWID | SEQUENCE

( column [, column]... ) }]...

[ “new_values_clause” ]

];

The FORCE clause gives the ALTER MATERIALIZED VIEW LOG statement new behavior if the specified filter column in the materialized view log already exists. Instead of failing with an error, this extended ALTER statement amends the materialized view log information specified in this command that is not already being captured. Information specified in this command that is already captured in the materialized view log is ignored without an error. Information that is already being captured in the materialized view log, but not specified in the command, is unaffected and continues to be captured. Note that if the added element to the materialized view log does not exist, this option (i.e., FORCE) has no impact and the statement behaves the same way as the existing ALTER MATERIALIZED VIEW LOG statement.

The following information is appended by the ALTER MATERIALIZED VIEW LOG FORCE statement: rowid, primary key, object id, sequence, filter columns, including new values. The following are some examples using the syntax extensions.

### EXAMPLE 1

ALTER MATERIALIZED VIEW LOG FORCE on SALES to add a sequence column and two filter columns.
ALTER MATERIALIZED VIEW LOG FORCE ON sh.sales
ADD SEQUENCE (prod_id, amount_sold);

If the materialized view Log on sales already exists and contains prod_id, no error is reported and sequence and amount_sold columns are added.

### EXAMPLE 2

ALTER MATERIALIZED VIEW LOG FORCE on SALES to include new values.
ALTER MATERIALIZED VIEW LOG FORCE ON sh.sales
INCLUDING NEW VALUES;

If this materialized view log exists and includes new values, there is no error and no change will be made to the materialized view log. If this materialized view log exists and does not include new values, it will include new values after this command.

### EXAMPLE 3

ALTER MATERIALIZED VIEW LOG FORCE on SALES containing a sequence column and two filter columns, cust_id, and amount_sold where sequence and prod_id exist the original materialized view log.
ALTER MATERIALIZED VIEW LOG FORCE ON sh.sales
ADD SEQUENCE (cust_id, amount_sold);

The existing materialized view log column, prod_id is not affected after the above statement execution. The statement execution adds two filter columns as cust_id and amount_sold.

The amendments to the materialized view log are not retroactive. The ALTER MATERIALIZED VIEW LOG FORCE does not affect existing rows in the log. Rather, all subsequent new rows added to the log will include the amended log columns.

(this description does not fit here as it's nothing to do with MV log)

If FORCE is specified, the following errors will not appear even if the corresponding information exists in the materialized view log and is specified in the ALTER MATERIALIZED VIEW LOG command:
“materialized view log on % s. % s already has [rowid|primary keys|object id|sequence]”
“duplicate filter column”

If FORCE is specified with excluding new values clause and the materialized view log exists, the following error will be thrown.
“Cannot exclude new values when altering existing materialized view log on % s. % s”

The following describes the interface of the DBMS_ADVISOR.TUNE_MVIEW( ) procedure.

DBMS_ADVISOR.TUNE_MVIEW(task_name IN OUT VARCHAR2,

mv_create_stmt IN [CLOB|VARCHAR2])

The following table shows parameter options.

| Parameter Name | Type | Description |
|---|---|---|
| task_name | VARCHAR2 | The user can input a task name and |
| | | later use the name to look up the |
| | | tune_mview results through tune_{—} |
| | | mview catalog view. If the parameter |
| | | is not specified, the system will |
| | | generate a name and return to the |
| | | user. |
| mv_create_stmt | CLOB or | The original MV creation statement. |
| | VARCHAR2 | |

The following are nine examples of test cases with different types of defining queries appearing in CREATE MATERIALIZED VIEW statements. They are tunable and amendable by DBMS_ADVISOR.TUNE_MVIEW. It is noted that the foregoing are merely exemplary applications of the present invention, and are not intended to limit or narrow the scope of the present invention.

Case 1: Materialized Aggregated View

INPUT: Original Materialized View DDL:

create materialized view may refresh fast enable query rewrite as

select v.vendor_name, s.supplier_name, avg(country_key) as ak

from vendor v, supplier s

where v.vendor_key=s.vendor_key

group by v.vendor_name, s.supplier_name

OUTPUT:

IMPLEMENTATION Recommendations:

CREATE MATERIALIZED VIEW LOG ON “GROCERY2”.“SUPPLIER” WITH ROWID, SEQUENCE (“SUPPLIER_NAME”,“COUNTRY_KEY”,“VENDOR_KEY”) INCLUDING NEW VALUES;

ALTER MATERIALIZED VIEW LOG FORCE ON “GROCERY2”.“SUPPLIER” ADD ROWID, SEQUENCE (“SUPPLIER_NAME”,“COUNTRY_KEY”,“VENDOR_KEY”) INCLUDING NEW VALUES;

CREATE MATERIALIZED VIEW LOG ON “GROCERY2”.“VENDOR” WITH ROWID, SEQUENCE (“VENDOR_KEY”,“VENDOR_NAME”) INCLUDING NEW VALUES;

ALTER MATERIALIZED VIEW LOG FORCE ON “GROCERY2”.“VENDOR” ADD ROWID, SEQUENCE (“VENDOR_KEY”,“VENDOR_NAME”) INCLUDING NEW VALUES;

CREATE MATERIALIZED VIEW GROCERY2.MAV;

REFRESH FAST WITH ROWID;

ENABLE QUERY REWRITE

AS

SELECT GROCERY2.VENDOR.VENDOR_NAME C1,
GROCERY2.SUPPLIER.SUPPLIER_NAME C2,
SUM(“GROCERY2”.“SUPPLIER”.“COUNTRY_KEY”) M1,
COUNT (“GROCERY2”.“SUPPLIER”.“COUNTRY_KEY”) M2,COUNT(*) M3
FROM GROCERY2.VENDOR, GROCERY2.SUPPLIER
   WHERE GROCERY2.SUPPLIER.VENDOR_KEY=
GROCERY2.VENDOR.VENDOR_KEY
   GROUP BY GROCERY2.VENDOR.VENDOR_NAME,
GROCERY2.SUPPLIER.SUPPLIER_NAME;
   UNDO Recommendations:

DROP MATERIALIZED VIEW GROCERY2.MAV;

Case 2: Materialized Join View

INPUT: Original Materialized View DDL:

create materialized view mjv refresh fast enable query rewrite as

select s.store_name, su.supplier_name, f.dollar_sales,

f.dollar_cost

from fact f, store s, product p, supplier su

where f.store_key=s.store_key and
p.product_key1=f.product_key1 and
p.product_key2=f.product_key2 and
p.supplier_key=su.supplier_key
   OUTPUT:
   IMPLEMENTATION Recommendations:
   CREATE MATERIALIZED VIEW LOG ON “GROCERY2”.“FACT” WITH ROWID;
   ALTER MATERIALIZED VIEW LOG FORCE ON “GROCERY2”.“FACT” ADD ROWID;
   CREATE MATERIALIZED VIEW LOG ON “GROCERY2”.“STORE” WITH ROWID;
   ALTER MATERIALIZED VIEW LOG FORCE ON “GROCERY2”.“STORE” ADD ROWID;
   CREATE MATERIALIZED VIEW LOG ON “GROCERY2”.“SUPPLIER” WITH ROWID;
   ALTER MATERIALIZED VIEW LOG FORCE ON “GROCERY2”.“SUPPLIER” ADD ROWID;
   CREATE MATERIALIZED VIEW LOG ON “GROCERY2”.“PRODUCT” WITH ROWID;
   ALTER MATERIALIZED VIEW LOG FORCE ON “GROCERY2”.“PRODUCT” ADD ROWID;
   CREATE MATERIALIZED VIEW GROCERY2.MJV

REFRESH FAST WITH ROWID;

ENABLE QUERY REWRITE

AS

SELECT GROCERY2.PRODUCT.ROWID C1, GROCERY2.SUPPLIER.ROWID C2,
GROCERY2.STORE.ROWID C3, GROCERY2.FACT.ROWID C4,
“GROCERY2”.“FACT”.“DOLLAR_COST” M1,

“GROCERY2”.“FACT”.“DOLLAR_SALES” M2,
“GROCERY2”.“STORE”.“STORE_NAME” M3,
“GROCERY2”.“SUPPLIER”.“SUPPLIER_NAME” M4
   FROM GROCERY2.PRODUCT, GROCERY2.SUPPLIER, GROCERY2.STORE,

GROCERY2.FACT

WHERE GROCERY2.SUPPLIER.SUPPLIER_KEY=

GROCERY2.PRODUCT.SUPPLIER_KEY AND
GROCERY2.FACT.PRODUCT_KEY2=

GROCERY2.PRODUCT.PRODUCT_KEY2 AND

GROCERY2.FACT.PRODUCT_KEY1=

GROCERY2.PRODUCT.PRODUCT_KEY1 AND

GROCERY2.FACT.STORE_KEY=GROCERY2.STORE.STORE_KEY

UNDO Recommendations:

DROP MATERIALIZED VIEW GROCERY2.MJV

Case 2: Materialized Join View

INPUT: Original Materialized View DDL:

create materialized view mjv refresh fast enable query rewrite as

select s.store_name, su.supplier_name, f.dollar_sales,

f.dollar_cost

from fact f, store s, product p, supplier su

where f.store_key=s.store_key and
p.product_key1=f.product_key1 and
p.product_key2=f.product_key2 and
p.supplier_key=su.supplier_key
   OUTPUT:
   IMPLEMENTATION Recommendations:
   CREATE MATERIALIZED VIEW LOG ON “GROCERY2”.“FACT” WITH ROWID; ALTER MATERIALIZED VIEW LOG FORCE ON “GROCERY2”.“FACT” ADD ROWID;
   CREATE MATERIALIZED VIEW LOG ON “GROCERY2”.“STORE” WITH ROWID;
   ALTER MATERIALIZED VIEW LOG FORCE ON “GROCERY2”.“STORE” ADD ROWID;
   CREATE MATERIALIZED VIEW LOG ON “GROCERY2”.“SUPPLIER” WITH ROWID;
   ALTER MATERIALIZED VIEW LOG FORCE ON “GROCERY2”.“SUPPLIER” ADD ROWID;
   CREATE MATERIALIZED VIEW LOG ON “GROCERY2”.“PRODUCT” WITH ROWID;
   ALTER MATERIALIZED VIEW LOG FORCE ON “GROCERY2”.“PRODUCT” ADD ROWID;
   CREATE MATERIALIZED VIEW GROCERY2.MJV

REFRESH FAST WITH ROWID;

ENABLE QUERY REWRITE

AS

SELECT GROCERY2.PRODUCT.ROWID C1, GROCERY2.SUPPLIER.ROWID C2,
GROCERY2.STORE.ROWID C3, GROCERY2.FACT.ROWID C4,
“GROCERY2”.“FACT”.“DOLLAR_COST” M1,
“GROCERY2”.“FACT”.“DOLLAR_SALES” M2,
“GROCERY2”.“STORE”.“STORE_NAME” M3,
“GROCERY2”.“SUPPLIER”.“SUPPLIER_NAME” M4
   FROM GROCERY2.PRODUCT, GROCERY2.SUPPLIER, GROCERY2.STORE,

GROCERY2.FACT

WHERE GROCERY2.SUPPLIER.SUPPLIER_KEY=

GROCERY2.PRODUCT.SUPPLIER_KEY AND
GROCERY2.FACT.PRODUCT_KEY2=
GROCERY2.PRODUCT.PRODUCT_KEY2 AND
GROCERY2.FACT.PRODUCT_KEY1=
GROCERY2.PRODUCT.PRODUCT_KEY1 AND

GROCERY2.FACT.STORE_KEY=GROCERY2.STORE.STORE_KEY

UNDO Recommendations:

DROP MATERIALIZED VIEW GROCERY2.MJV

Case 3: Materialized View with SELECT DISTINCT

INPUT: Original Materialized View DDL:

create materialized view mv1

refresh fast

as

select distinct vendor_name from vendor

OUTPUT:

IMPLEMENTATION Recommendations:

CREATE MATERIALIZED VIEW LOG ON “GROCERY2”.“VENDOR” WITH ROWID, SEQUENCE (“VENDOR_NAME”) INCLUDING NEW VALUES;

ALTER MATERIALIZED VIEW LOG FORCE ON “GROCERY2”.“VENDOR” ADD ROWID, SEQUENCE (“VENDOR_NAME”) INCLUDING NEW VALUES;

CREATE MATERIALIZED VIEW GROCERY2.MV1

REFRESH FAST WITH ROWID

DISABLE QUERY REWRITE

AS

SELECT GROCERY2.VENDOR.VENDOR_NAME C1, COUNT(*) M1

FROM GROCERY2.VENDOR

GROUP BY GROCERY2.VENDOR.VENDOR_NAME;

UNDO Recommendations:

DROP MATERIALIZED VIEW GROCERY2.MV1;

Case 4: Materialized View with COUNT DISTINCT

INPUT: Original Materialized View DDL:

create materialized view mv3

refresh fast

enable query rewrite

as

select supplier_name, count(distinct country_key) as cd from supplier

group by supplier_name

OUTPUT:

IMPLEMENTATION Recommendations:

CREATE MATERIALIZED VIEW LOG ON “GROCERY2”.“SUPPLIER” WITH ROWID, SEQUENCE (“SUPPLIER_NAME”,“COUNTRY_KEY”) INCLUDING NEW VALUES;

ALTER MATERIALIZED VIEW LOG FORCE ON “GROCERY2”.“SUPPLIER” ADD ROWID, SEQUENCE (“SUPPLIER_NAME”,“COUNTRY_KEY”) INCLUDING NEW VALUES;

CREATE MATERIALIZED VIEW GROCERY2.MV3

REFRESH FAST WITH ROWID

ENABLE QUERY REWRITE

AS

SELECT GROCERY2.SUPPLIER.COUNTRY_KEY C1,

GROCERY2.SUPPLIER.SUPPLIER_NAME C2,

COUNT(*) M1

FROM GROCERY2.SUPPLIER

GROUP BY GROCERY2.SUPPLIER.COUNTRY_KEY,

GROCERY2.SUPPLIER.SUPPLIER_NAME

UNDO Recommendations:

DROP MATERIALIZED VIEW GROCERY2.MV3

Case 5: Materialized View with Inline View

INPUT: Original Materialized View DDL:

create materialized view inline_view_mv4

refresh fast enable query rewrite as

select p.display_type, avg(s.sum_sales)

from promotion p,

(select s.store_name, f.promotion_key, sum(dollar_sales)

sum_sales

from store s, fact f where s.store_key=f.store_key

group by s.store_name, f.promotion_key) s

where p.promotion_key=s.promotion_key group by

p.display_type

OUTPUT:

IMPLEMENTATION Recommendations:

CREATE MATERIALIZED VIEW LOG ON “GROCERY2”.“FACT” WITH ROWID, SEQUENCE (“STORE_KEY”,“PROMOTION_KEY”,“DOLLAR_SALES”) INCLUDING NEW VALUES;

ALTER MATERIALIZED VIEW LOG FORCE ON “GROCERY2”.“FACT” ADD ROWID, SEQUENCE (“STORE_KEY”,“PROMOTION_KEY”,“DOLLAR_SALES”) INCLUDING NEW VALUES;

CREATE MATERIALIZED VIEW LOG ON “GROCERY2”.“STORE” WITH ROWID, SEQUENCE (“STORE_KEY”,“STORE_NAME”) INCLUDING NEW VALUES;

ALTER MATERIALIZED VIEW LOG FORCE ON “GROCERY2”.“STORE” ADD ROWID, SEQUENCE (“STORE_KEY”,“STORE_NAME”) INCLUDING NEW VALUES;

CREATE MATERIALIZED VIEW GROCERY2.INLINE_VIEW_MV4$SUB1

REFRESH FAST WITH ROWID ON COMMIT

ENABLE QUERY REWRITE

AS

SELECT GROCERY2.STORE.STORE_NAME C1,
GROCERY2.FACT.PROMOTION_KEY C2,
SUM(“GROCERY2”.“FACT”.“DOLLAR_SALES”) M1,
COUNT (“GROCERY2”.“FACT”.“DOLLAR_SALES”) M2,
COUNT(*) M3

FROM GROCERY2.STORE, GROCERY2.FACT

WHERE GROCERY2.FACT.STORE_KEY=

GROCERY2.STORE.STORE_KEY

GROUP BY GROCERY2.STORE.STORE_NAME,

GROCERY2.FACT.PROMOTION_KEY;

CREATE MATERIALIZED VIEW GROCERY2.INLINE_VIEW_MV4

REFRESH FORCE WITH ROWID

ENABLE QUERY REWRITE

AS

SELECT “P”.“DISPLAY_TYPE” “DISPLAY_TYPE”,

AVG(“S”.“SUM_SALES”)

“AVG(S.SUM_SALES)”

FROM “PROMOTION” “P”,
(SELECT “INLINE_VIEW_MV4$SUB1”.“C1” “STORE_NAME”,
   “INLINE_VIEW_MV4$SUB1”.“C2”
      “PROMOTION_KEY”,

“INLINE_VIEW_MV4$SUB1”.“M1” “SUM_SALES”

FROM “GROCERY2”.“INLINE_VIEW_MV4$SUB1”

“INLINE_VIEW_MV4$SUB1”)

“S”

WHERE “P”.“PROMOTION_KEY”=“S”.“PROMOTION_KEY”

GROUP BY “P”.“DISPLAY_TYPE”;

UNDO Recommendations:

DROP MATERIALIZED VIEW GROCERY2.INLINE_VIEW_MV4$SUB1

DROP MATERIALIZED VIEW GROCERY2.INLINE_VIEW_MV4;

Case 6: Materialized View with Subquery

INPUT: Original Materialized View DDL:

create materialized view subquery_mv3 refresh fast enable

query rewrite as

select store_key, unit_sales, dollar_sales from fact
where store_key in (select store_key from store
   where store_name in (select supplier_name from
      supplier

where supplier_key=store_key))

OUTPUT:

IMPLEMENTATION Recommendations:

CREATE MATERIALIZED VIEW LOG ON “GROCERY2”.“SUPPLIER” WITH ROWID

ALTER MATERIALIZED VIEW LOG FORCE ON “GROCERY2”.“SUPPLIER” ADD ROWID

CREATE MATERIALIZED VIEW GROCERY2.SUBQUERY_MV3$SUB1

REFRESH FAST WITH ROWID ON COMMIT

ENABLE QUERY REWRITE

AS

SELECT GROCERY2.SUPPLIER.ROWID C1,
“GROCERY2”.“SUPPLIER”.“SUPPLIER_KEY” M1,
   “GROCERY2”.“SUPPLIER”.“SUPPLIER_NAME” M2

FROM GROCERY2.SUPPLIER

CREATE MATERIALIZED VIEW GROCERY2.SUBQUERY_MV3

REFRESH FORCE WITH ROWID

ENABLE QUERY REWRITE

AS

SELECT “FACT”.“STORE_KEY” “STORE_KEY”,“FACT”.“UNIT_SALES”

“UNIT_SALES”,
“FACT”.“DOLLAR_SALES” “DOLLAR_SALES”

FROM “FACT” “FACT”

WHERE “FACT”.“STORE_KEY”=

ANY (SELECT “SYS_ALIAS_{—}1”.“STORE_KEY” FROM “STORE”

“SYS_ALIAS_{—}1”

WHERE “SYS_ALIAS_{—}1”.“STORE_NAME”=

ANY (SELECT “SUBQUERY_MV3$SUB1”.“M2”

FROM “GROCERY2”.“SUBQUERY_MV3$SUB1” “SUBQUERY_MV3$SUB1”

WHERE “SUBQUERY_MV3$SUB1”.“M1”=“SYS_ALIAS_{—}1”.“STORE_KEY”))

DBMS_ADVANCED_REWRITE.BUILD_SAFE_REWRITE_EQUIVALENCE

(‘GROCERY2.SUBQUERY_MV3$RWEQ’,

‘select store_key, unit_sales, dollar_sales from fact

where store_key in (select store_key from store where store_name in

(select supplier_name from supplier
where supplier_key=
   store_key))’,

‘SELECT “FACT”.“STORE_KEY” “STORE_KEY”,“FACT”.“UNIT_SALES”

“UNIT_SALES”,

“FACT”.“DOLLAR_SALES” “DOLLAR_SALES” FROM “FACT”

“FACT”

WHERE “FACT”.“STORE_KEY”=
ANY (SELECT “SYS_ALIAS_{—}1”.“STORE_KEY” FROM “STORE”
   “SYS_ALIAS_{—}1”

WHERE “SYS_ALIAS_{—}1”.“STORE_NAME”=
ANY (SELECT “SUBQUERY_MV3$SUB1”.“M2”
   FROM “GROCERY2”.“SUBQUERY_MV3$SUB1” “SUBQUERY_MV3$SUB1”

WHERE

“SUBQUERY_MV3$SUB1”.“M1”=“SYS_ALIAS_{—}1”.“STORE_KEY”))’, 1063410374)

UNDO Recommendations:

DROP MATERIALIZED VIEW GROCERY2.SUBQUERY_MV3$SUB1

DROP MATERIALIZED VIEW GROCERY2.SUBQUERY_MV3

DBMS_ADVANCED_REWRITE.DROP_REWRITE_EQUIVALENCE(‘GROCERY2.SUBQUERY_MV3$RWEQ’)

Case 7: Materialized View with Set Operator

INPUT: Original Materialized View DDL:

create materialized view set_mv1

refresh fast enable query rewrite as
select vendor_name from vendor minus select supplier_name
   from supplier
   OUTPUT:
   IMPLEMENTATION Recommendations:
   CREATE MATERIALIZED VIEW LOG ON “GROCERY2”.“VENDOR” WITH ROWID ALTER MATERIALIZED VIEW LOG FORCE ON “GROCERY2”.“VENDOR” ADD
   ROWID
   CREATE MATERIALIZED VIEW GROCERY2.SET_MV1$SUB1

REFRESH FAST WITH ROWID ON COMMIT

ENABLE QUERY REWRITE

AS

SELECT GROCERY2.SUPPLIER.ROWID C1,
“GROCERY2”.“SUPPLIER”.“SUPPLIER_NAME” M1

FROM GROCERY2.SUPPLIER

CREATE MATERIALIZED VIEW GROCERY2.SET_MV1$SUB2

REFRESH FAST WITH ROWID ON COMMIT

ENABLE QUERY REWRITE

AS

SELECT GROCERY2.VENDOR.ROWID C1,
“GROCERY2”.“VENDOR”.“VENDOR_NAME” M1

FROM GROCERY2.VENDOR

CREATE MATERIALIZED VIEW GROCERY2.SET_MV1

REFRESH FORCE WITH ROWID

ENABLE QUERY REWRITE

AS
(SELECT “SET_MV1$SUB2”.“M1” “VENDOR_NAME”

FROM “GROCERY2”.“SET_MV1$SUB2” “SET_MV1$SUB2”)

MINUS
(SELECT “SET_MV1$SUB1”.“M1” “SUPPLIER_NAME”

FROM “GROCERY2”.“SET_MV1$SUB1” “SET_MV1$SUB1”)

DBMS_ADVANCED_REWRITE.BUILD_SAFE_REWRITE_EQUIVALENCE

(‘GROCERY2.SET_MV1$RWEQ’,

‘select vendor_name from vendor minus select supplier_name

from supplier’,

‘(SELECT “SET_MV1$SUB2”.“M1” “VENDOR_NAME”

FROM “GROCERY2”.“SET_MV1$SUB2” “SET_MV1$SUB2”)

MINUS
(SELECT “SET_MV1$SUB1”.“M1” “SUPPLIER_NAME”

FROM “GROCERY2”.“SET_MV1$SUB1” “SET_MV1$SUB1”)’, −1034076953)

UNDO Recommendations:

DROP MATERIALIZED VIEW GROCERY2.SET_MV1$SUB1

DROP MATERIALIZED VIEW GROCERY2.SET_MV1$SUB2

DROP MATERIALIZED VIEW GROCERY2.SET_MV1

DBMS_ADVANCED REWRITE.DROP REWRITE_EQUIVALENCE(‘GROCERY2.SET_MV1$RWEQ’)

Case 8: Materialized View with Inline View and Set Operator

INPUT: Original Materialized View DDL:

create materialized view inline_view_mv3

refresh fast enable query rewrite as

select p.display_type, avg(f.dollar_sales)

from promotion p, fact f,
(select vendor_name name, vendor_key key from vendor
union all
select supplier_name name, supplier_key key from supplier) s

where f.promotion_key=p.promotion_key and
f.store_key s.key and s.name=‘ORACLE’

group by p.display_type

OUTPUT:

IMPLEMENTATION Recommendations:

CREATE MATERIALIZED VIEW LOG ON “GROCERY2”.“SUPPLIER” WITH ROWID

ALTER MATERIALIZED VIEW LOG FORCE ON “GROCERY2”.“SUPPLIER” ADD ROWID

CREATE MATERIALIZED VIEW LOG ON “GROCERY2”.“VENDOR” WITH ROWID

ALTER MATERIALIZED VIEW LOG FORCE ON “GROCERY2”.“VENDOR” ADD ROWID

CREATE MATERIALIZED VIEW GROCERY2.INLINE_VIEW_MV3$SUB1

REFRESH FAST WITH ROWID ON COMMIT

ENABLE QUERY REWRITE

AS

SELECT GROCERY2.SUPPLIER.ROWID C1,
“GROCERY2”.“SUPPLIER”.“SUPPLIER_KEY” M1,
“GROCERY2”.“SUPPLIER”.“SUPPLIER_NAME” M2

FROM GROCERY2.SUPPLIER

CREATE MATERIALIZED VIEW GROCERY2.INLINE_VIEW_MV3$SUB2

REFRESH FAST WITH ROWID ON COMMIT

ENABLE QUERY REWRITE

AS

SELECT GROCERY2.VENDOR.ROWID C1,
“GROCERY2”.“VENDOR”.“VENDOR_KEY” M1,
“GROCERY2”.“VENDOR”.“VENDOR_NAME” M2

FROM GROCERY2.VENDOR

CREATE MATERIALIZED VIEW GROCERY2.INLINE_VIEW_MV3

REFRESH FORCE WITH ROWID

ENABLE QUERY REWRITE

AS

SELECT “P”.“DISPLAY_TYPE” “DISPLAY_TYPE”,
AVG(“F”.“DOLLAR_SALES”)
   “AVG(F.DOLLAR_SALES)”

FROM “PROMOTION” “P”,“FACT” “F”,
((SELECT “INLINE_VIEW_MV3$SUB2”.“M2”
   “NAME”,“INLINE_VIEW_MV3$SUB2”.“M1” “KEY”

FROM “GROCERY2”.“INLINE_VIEW_MV3$SUB2”

“INLINE_VIEW_MV3$SUB2”)

UNION ALL
(SELECT “INLINE_VIEW_MV3$SUB1”.“M2”
   “NAME”,“INLINE_VIEW_MV3$SUB1”.“M1” “KEY”

FROM “GROCERY2”.“INLINE_VIEW_MV3$SUB1”

“INLINE_VIEW_MV3$SUB1”))

“S”

WHERE “F”.“PROMOTION_KEY”=“P”.“PROMOTION_KEY” AND
“F”.“STORE_KEY”=“S”.“KEY” AND “S”. “NAME”=‘ORACLE’

GROUP BY “P”.“DISPLAY_TYPE”

UNDO Recommendations:

DROP MATERIALIZED VIEW

GROCERY2.INLINE_VIEW MV3$SUB1

DROP MATERIALIZED VIEW GROCERY2.INLINE_VIEW_MV3$SUB2

DROP MATERIALIZED VIEW GROCERY2.INLINE_VIEW_MV3

Case 9: Materialized View with Subquery and Set Operator

INPUT: Original Materialized View DDL:

create materialized view subquery_mv2 refresh fast enable

query rewrite as

select store_key, unit_sales, dollar_sales from fact
where store_key in (select store_key from store where
   store_name=‘SONY’

union all

select vendor_key from vendor where vendor_name=‘NEC’)

OUTPUT:

IMPLEMENTATION Recommendations:

CREATE MATERIALIZED VIEW LOG ON “GROCERY2”.“VENDOR” WITH ROWID ALTER MATERIALIZED VIEW LOG FORCE ON “GROCERY2”.“VENDOR” ADD ROWID

CREATE MATERIALIZED VIEW GROCERY2.SUBQUERY_MV2$SUB1

REFRESH FAST WITH ROWID ON COMMIT

ENABLE QUERY REWRITE

AS

SELECT GROCERY2.VENDOR.ROWID C1,
“GROCERY2”.“VENDOR”.“VENDOR_KEY” M1

FROM GROCERY2.VENDOR WHERE (GROCERY2.VENDOR.VENDOR_NAME=‘NEC’)

CREATE MATERIALIZED VIEW GROCERY2.SUBQUERY_MV2$SUB2

REFRESH FAST WITH ROWID ON COMMIT ENABLE QUERY REWRITE

AS

SELECT GROCERY2.STORE.ROWID C1,
“GROCERY2”.“STORE”.“STORE_KEY” M1

FROM GROCERY2.STORE WHERE (GROCERY2.STORE.STORE_NAME=

‘SONY’)

CREATE MATERIALIZED VIEW GROCERY2.SUBQUERY_MV2

REFRESH FORCE WITH ROWID

ENABLE QUERY REWRITE

AS

SELECT “FACT”.“STORE_KEY” “STORE_KEY”,“FACT”.“UNIT_SALES”
“UNIT_SALES”,
“FACT”.“DOLLAR_SALES” “DOLLAR_SALES”

FROM “FACT” “FACT”

WHERE “FACT”.“STORE_KEY”=

ANY ((SELECT “SUBQUERY_MV2$SUB2”.“M1”

FROM “GROCERY2”.“SUBQUERY_MV2$SUB2” “SUBQUERY_MV2$SUB2”)

UNION ALL

(SELECT “SUBQUERY_MV2$SUB1”.“M1”

FROM “GROCERY2”.“SUBQUERY_MV2$SUB1” “SUBQUERY_MV2$SUB1”))

DBMS_ADVANCED_REWRITE.BUILD_SAFE_REWRITE_EQUIVALENCE

(‘GROCERY2.SUBQUERY_MV2$RWEQ’,

‘select store_key, unit_sales, dollar_sales from fact

where store_key in (select store_key from store where

store_name=‘SONY’

union all

select vendor_key from vendor where

vendor_name=‘NEC’)’,

‘SELECT “FACT”.“STORE_KEY” “STORE_KEY”,“FACT”.“UNIT_SALES”

“UNIT_SALES”,

“FACT”.“DOLLAR_SALES” “DOLLAR_SALES”

FROM “FACT” “FACT”

WHERE “FACT”.“STORE_KEY”=

ANY ((SELECT “SUBQUERY_MV2$SUB2”.“M1”

FROM “GROCERY2”.“SUBQUERY_MV2$SUB2” “SUBQUERY_MV2$SUB2”)

UNION ALL

(SELECT “SUBQUERY_MV2$SUB1”.“M1”

FROM “GROCERY2”.“SUBQUERY_MV2$SUB1”
“SUBQUERY_MV2$SUB1”))’, −28323944)
   UNDO Recommendations:
   DROP MATERIALIZED VIEW GROCERY2.SUBQUERY_MV2$SUB1
   DROP MATERIALIZED VIEW GROCERY2.SUBQUERY_MV2$SUB2
   DROP MATERIALIZED VIEW GROCERY2.SUBQUERY_MV2
   DBMS_ADVANCED REWRITE.DROP REWRITE_EQUIVALENCE(‘GROCERY2.SUBQUERY_MV2$RWEQ’)

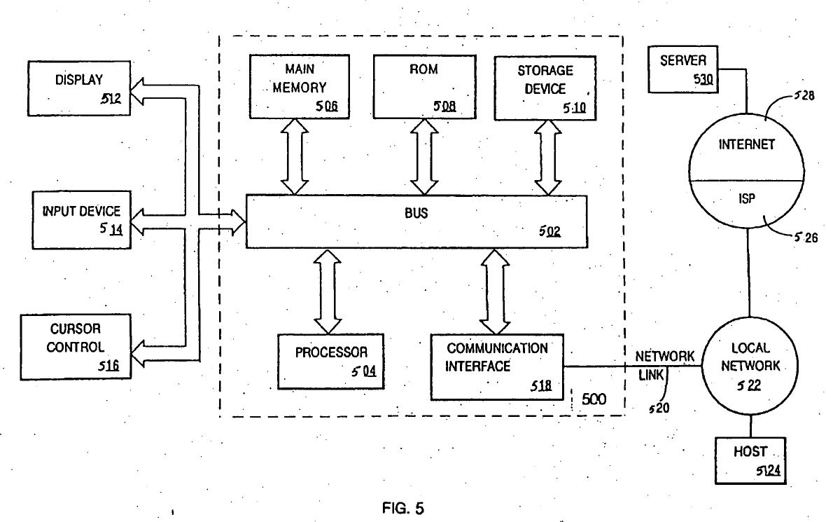

FIG. 5 illustrates a computer system 500 upon which embodiments of the invention may be implemented. As shown in FIG. 5, the system 500 generally includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. System 500 can also include a read only memory (ROM) 508 or other static storage device coupled to bus 502 for storing static information and instructions for processor 504. A storage device 510, such as a magnetic disk or optical disk, can be coupled to bus 502 for storing information and instructions.

Computer system 500 may also be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The disclosed embodiments are related to the use of computer system 500 for the mix incremental refresh of materialized views. According to one embodiment of the invention, the mix incremental refresh process of the disclosed embodiments can be provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hardwired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media can include for example, dynamic memory, such as main memory 506. Transmission media can include for example, coaxial cables, copper wire and fiber optics, including the wires that comprise bus 502. Transmission media can also take the form of acoustic or light waves, such as those generated during radio wave and infrared data communications.

Common forms of computer-readable media include for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

As illustrated in FIG. 5, the computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for incrementally refreshing materialized views as described herein.

The received code may be executed by processor 504 as it is received, and/or stored in storage device 510, or other non-volatile storage for later execution. In this manner, computer system 500 may obtain application code in the form of a carrier wave.

The disclosed embodiments provide the user with the interface (or a processing component) to create, fix or decompose a materialized view in an easier way. Common problems during materialized view creation such as missing materialized view log or filter columns, missing aggregate functions in the defining query, etc., are fixed. Depending on the need, the materialized view defining query can be decomposed into a number of secondary materialized views. The generated materialized view and/or materialized view log recommendations are recorded in the repository tables and accessible through catalog views.

Features of the present invention include materialized view defining query validation and analysis enhancements, materialized view log advisory and amendment mechanisms, defining query modification technique, decomposition and use of nested materialized views and support of query rewrite using rewrite equivalence.

In one embodiment the automatic enhancement of a user-specified materialized view definition includes automatic decomposition of a complex, user-specified materialized view definition into a set of one or more simpler but more capable materialized view definitions, automatic addition of columns required to support certain materialized view capabilities and automatic transforming a complex SQL form into an equivalent but simpler SQL form. This generally includes transforming, for example, SELECT DISTINCT X into SELECT X . . . GROUP BY X, and transforming SELECT X, COUNT(DISTINCT(Y)) . . . GROUP BY X into SELECT X,Y, COUNT(*) . . . GROUP BY X,Y.

The disclosed embodiments also provide automatic conditioning of the materialized view environment to enhanced materialized view capabilities, including the addition of new or enhancement of existing materialized view logs, the addition of new or enhancement of existing constraint definitions, the addition of new or enhancement of existing dimension definitions and rewrite equivalences.

The rewrite equivalences generally include automatic point-in-time validation of rewrite equivalences, continuous validation of rewrite equivalences, and application of rewrite equivalences to the decomposition process. The application of rewrite equivalences to the decomposition process can include the use of a checksum to ensure integrity of tune_mview determined rewrite equivalences.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of enhancing a materialized view comprising:
analyzing a defined query of the materialized view;
checking the requirements of the materialized view log;
generating execution scripts that automatically create and enhance the materialized view logs; and
tuning the materialized view.

2. The method of claim 1 further comprising determining if the defined query can be tuned.

3. The method of claim 2 further comprising detecting that the defined query of the materialized view has a complex defining query that cannot be tuned and returning an error message.

4. The method of claim 1 wherein the defined query is divided into a number of sub-queries, each sub-query being used as a defining query for each sub-materialized view and wherein an original defined query is modified to reference each sub-materialized view as a nested materialized view.

5. The method of claim 1 further comprising rewriting an original defined query in terms of the sub-materialized views to generate a modified defined query that replaces the original defined query.

6. The method of claim 4 further comprising applying rewrite equivalence to relate the original defined query to the modified defined query.

7. The method of claim 1 wherein tuning the materialized view further comprises fixing the defined query or decomposing the defined query to create a number of sub-materialized views.

8. The method of claim 7 wherein tuning the materialized view further comprises automatically adding required columns to support materialized view definitions.

9. The method of claim 7 wherein tuning the materialized view further comprises automatically rendering complex SQL forms into equivalent simpler forms.

10. The method of claim 1 wherein analyzing the defined query comprises outputting implementation and undo scripts.

11. A system for automated materialized view creation comprising:
a DDL validation system for examining an input query and determining if the query can be tuned;
an SQL analyzer system that receives a tunable input query from the DDL Validation system, analyzes the defined query and divides the defined query into one or more sub-queries, each sub-query being used as a defined query of a sub-materialized view;
a materialized view log analyzer system that compares a create statement generated by the SQL analyzer to base tables in the materialized view logs and creates materialized view logs if the logs do not exist and are required for the create statement; and
a query rewrite system to generate a modified defined query to replace the original defined query in terms of sub-materialized views.

12. The system of claim 11 further comprising a rewrite equivalence system to relate, when the original defining query has more than one sub-query, the original defined query to the modified query, match the original defined query to the modified query, and apply a security token to the original defined query to the modified query.

13. The system of claim 11 further comprising an advisory repository table system that records create and drop statements generated by the SQL analyzer system.

14. The system of claim 13 further comprising a catalog view system that allows a user to access the create and drop statements.

15. The system of claim 11 wherein the SQL analyzer system generates create statements and drop statements and records the create statements and the drop statements in the Advisor Repository Tables.

16. The system of claim 11 wherein the materialized view log analyzer automatically adds columns required to satisfy the materialized view log requirements.

17. The system of claim 11 wherein the query rewrite system receives the original defined query and rewrites the original defined query in terms of the sub-materialized views to generate a modified defined query that replaces the original defined query.

18. A materialized view tuning process:
generating a first output for a create process;
generating a second output for a drop process; and
recording the first and second output in advisor repository table and providing access to the first and second output through catalog views.

19. The method of claim 18 wherein generating the first output for the create process further comprises:
automatically fixing any materialized view log problems required for a materialized view fast refresh;
optimizing defining queries to enable fast refresh and general query rewrite;
decomposing a non-fast refreshable materialized view defining query into a number of sub-materialized views to create one or more fast refreshable sub-materialized views.

20. The method of claim 19 wherein the materialized view log problems include a non-existence of a materialized view log or missing columns on the materialized view log required for fast refresh.

21. The method of claim 19 further comprising appending new columns even if the materialized view log or log columns exist.

22. The method of claim 19 wherein optimizing defining queries includes adding new columns.

23. The method of claim 19 wherein generating a second output for the drop process further comprises generating a statement to reverse a create operation if the materialized view tuning process is to be restarted.

24. The method of claim 23 further comprising recording the first output and the second output in a repository table, wherein each output recorded in the repository table is labeled with a script type and an operation sequence number.

25. The method of claim 24 further comprising accessing a catalog view to access each output in a format order by the script type and the sequence number.

26. The method of claim 19 further comprising linking an original defining query to a modified defining query using a mapping query and using a check sum value to prevent the mapping query from being modified.
